(19) United States
(12) Patent Application Publication
(10) Pub. No.: US 2015/0025699 A1
(43) Pub. Date: Jan. 22, 2015

(54) TERMINAL DEVICE, VEHICLE MANAGEMENT INFORMATION GENERATION METHOD AND NON-TRANSITORY COMPUTER READABLE RECORDING MEDIUM FOR RECORDING A VEHICLE MANAGEMENT INFORMATION GENERATION PROGRAM

(71) Applicant: Kabushiki Kaisha Toshiba, Tokyo (JP)

(72) Inventor: Kyosuke Takahashi, Tokyo (JP)

(73) Assignee: Kabushiki Kaisha Toshiba, Tokyo (JP)

(21) Appl. No.: 14/069,134

(22) Filed: Oct. 31, 2013

(30) Foreign Application Priority Data
Jul. 17, 2013 (JP) 2013-148844

(51) Int. Cl. B60L 11/18

(52) U.S. Cl. CPC B60L 11/1838
USPC 700/291

(57) ABSTRACT

According to one embodiment, a terminal device includes a use schedule extractor and a vehicle management information generator. The use schedule extractor is configured to extract information related to a use schedule of a rechargeable vehicle from a use state of the terminal device. The vehicle management information generator configured to generate vehicle management information necessary for charge management of the rechargeable vehicle based on the information related to the use schedule.

### CROSS REFERENCE TO RELATED APPLICATIONS

This application is based upon and claims the benefit of priority from the prior Japanese Patent Application No. 2013-148844, filed on Jul. 17, 2013, the entire contents of which are incorporated herein by reference.

### FIELD

Embodiments described herein relate generally to a terminal device, a vehicle management information generation method and a non-transitory computer readable recording medium for recording a vehicle management information generation program.

### BACKGROUND

As electric vehicles and hybrid vehicles have been widely used in recent years, HEMS (Home Energy Management System) which manages charging of these vehicles is started as a new service. However, regarding a conventional HEMS, a user needs to actively set a use schedule on the HEMS, so it is troublesome for the user. Further, if the user forgets to set the use schedule, there may be a situation that the charging is not completed when it is needed.

### BRIEF DESCRIPTION OF THE DRAWINGS

FIG. 1 is a block diagram showing a schematic configuration of HEMS according a first embodiment.

FIG. 2 is a block diagram showing internal configurations of the terminal device 1 and the HEMS server 2.

FIG. 3 is a diagram showing an example of a data structure of the vehicle management information written to the memory device 15.

FIG. 4 is a sequence diagram showing an example of a processing operation of the HEMS.

FIG. 5 is a diagram showing an example of the vehicle management information displayed on the display 16.

### DETAILED DESCRIPTION

In general, according to one embodiment, a terminal device includes a use schedule extractor and a vehicle management information generator. The use schedule extractor is configured to extract information related to a use schedule of a rechargeable vehicle from a use state of the terminal device. The vehicle management information generator configured to generate vehicle management information necessary for charge management of the rechargeable vehicle based on the information related to the use schedule.

Hereinafter, embodiments will be described with reference to the drawings.

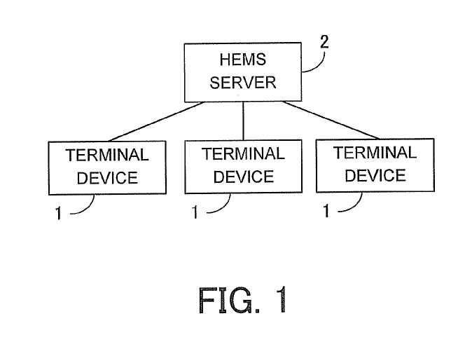

FIG. 1 is a block diagram showing a schematic configuration of HEMS according a first embodiment. The HEMS performs V2H (Vehicle to Home) management and the like. The HEMS includes a terminal device 1 and a HEMS server 2. The terminal device 1 is a device used by a user and is an electronic device such as, for example, a personal computer, a tablet, and a smartphone. Although three terminal devices 1 are drawn in FIG. 1, the number of the terminal devices 1 is not limited. For example, one HEMS server 2 is installed in a home. Each terminal device 1 can communicate with the HEMS server 2 by a wireless LAN or the like.

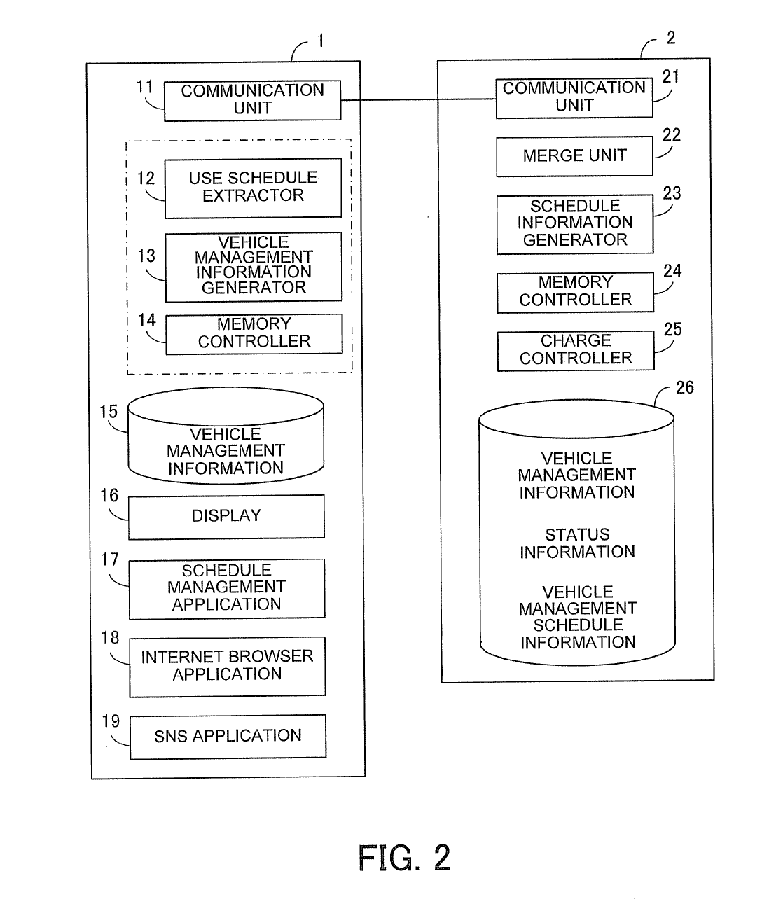

FIG. 2 is a block diagram showing internal configurations of the terminal device 1 and the HEMS server 2. For simplicity, only one terminal device 1 is drawn in FIG. 2.

The terminal device 1 includes a communication unit 11 to communicate with the HEMS server 2.

Further, the terminal device 1 includes a use schedule extractor 12, a vehicle management information generator 13, and a memory controller 14. These components may be realized as a vehicle management information generation application by executing a vehicle management information generation program by a processor (not shown in the drawings) of the terminal device 1.

The use schedule extractor 12 detects events from a use state of the terminal device 1 and extracts information assumed to be for using a rechargeable vehicle from among the detected events as information related to a use schedule of a rechargeable vehicle. The rechargeable vehicle may be not only a vehicle such as an electric vehicle (EV) and a plug-in hybrid vehicle (PHV), but also an electric power assist bicycle and an electric motorcycle.

The vehicle management information generator 13 generates vehicle management information necessary for charge management of the rechargeable vehicle from the extracted information related to a use schedule. It is desirable that the vehicle management information includes at least a date and time to be used and a distance to be used of the rechargeable vehicle. This is because it is necessary to charge the rechargeable vehicle to be able to run the distance to be used before the date and time to be used. If there is a plurality of candidates of vehicle to be used (for example, when a plurality of vehicles are possessed at home), it is desirable that the vehicle management information includes a type of vehicle to be used.

The memory controller 14 writes the generated vehicle management information to a memory device 15. Although FIG. 1 shows an example in which the memory device 15 is located in the terminal device 1, the memory device 15 may be located in the HEMS server 2. In this case, the memory controller 14 writes the vehicle management information to the memory device 15 in the HEMS server 2 through the communication unit 11. The memory device 15 may be a so-called cloud type device. Also in this case, the memory controller 14 writes the vehicle management information to the external memory device 15 through the communication unit 11.

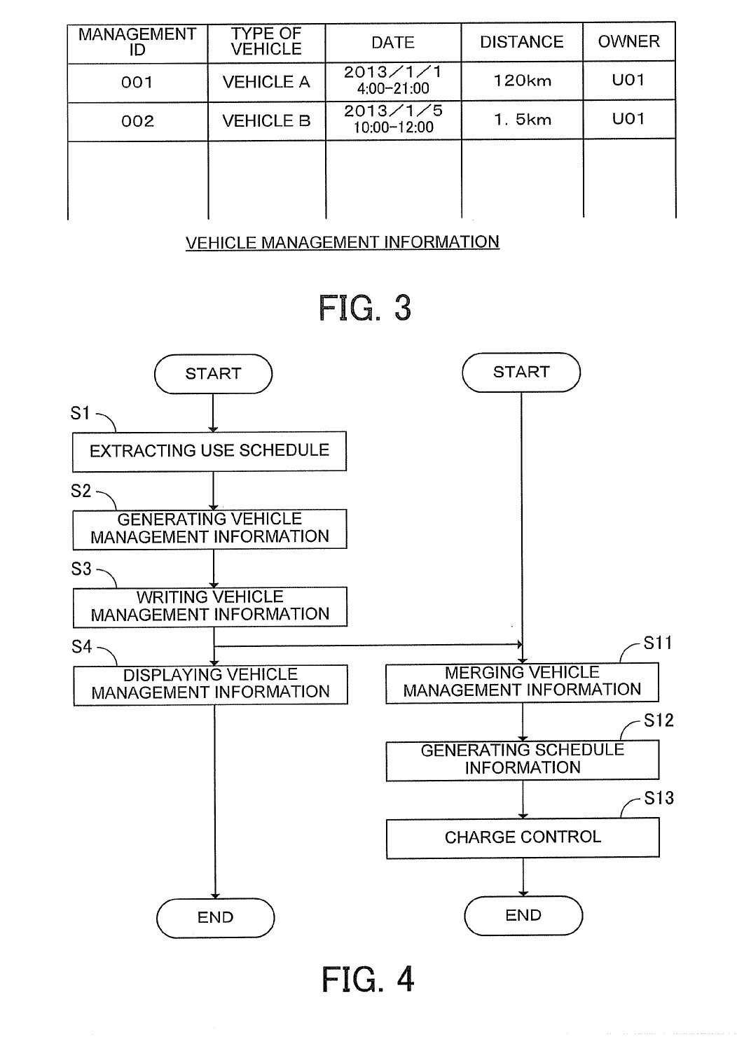

FIG. 3 is a diagram showing an example of a data structure of the vehicle management information written to the memory device 15. The vehicle management information includes a type of vehicle to be used, a time and date to be used, a distance to be used, and owner information by using a management ID as a key. The owner information is information to identify a user of the terminal device 1. The vehicle management information is generated for each terminal device 1.

The generation method of the vehicle management information will be described later.

Let us return to FIG. 2. The terminal device may include a display 16. The display 16 displays that the vehicle management information generation application is running and displays the generated vehicle management information.

In the terminal device 1, various applications such as a schedule management application 17, an Internet browser application 18, and an SNS (Social Networking Service) application 19 may be installed.

On the other hand, the HEMS server 2 includes a communication unit 21 to communicate with the terminal device 1, a merge unit 22, a schedule information generator 23, a memory controller 24, a charge controller 25, and a memory device 26.

The merge unit 22 acquires vehicle management information generated by each terminal device 1 and, when a plurality of terminal devices 1 are provided, merges the vehicle management information as needed. Here, the “merge” means that when the vehicle management information generated by one terminal device 1 coincides with that generated by another terminal device 1, the two pieces of vehicle management information are integrated (merged). The merged vehicle management information is written to the memory device 26 by the memory controller 24.

The schedule information generator 23 generates vehicle management schedule information on the basis of the (merged) vehicle management information written to the memory device 26 and status information of a rechargeable vehicle (remaining power of the rechargeable vehicle and the like). The vehicle management schedule information is a schedule indicating when and which rechargeable vehicle should be charged. The generated vehicle management schedule information is written to the memory device 26 by the memory controller 24.

The charge controller 25 charges the rechargeable vehicle according to the vehicle management schedule information written to the memory controller 24.

FIG. 4 is a sequence diagram showing an example of a processing operation of the HEMS. First, the use schedule extractor 12 of the terminal device 1 extracts information related to a use schedule of a rechargeable vehicle from the use state of the terminal device 1 (step S1). At this time, the use schedule extractor 12 may extract the use schedule from the application installed in the terminal device 1.

For example, the use schedule extractor 12 extracts information indicating when and where to go, which is registered in the schedule management application 17. Then, the use schedule extractor 12 considers a purpose and a destination, and when it is estimated that the rechargeable vehicle will be used, the use schedule extractor 12 holds the extracted information. For example, when the purpose is “fishing” and the destination is far away from a station, it is estimated that the rechargeable vehicle will be used.

Or, the use schedule extractor 12 may refer to a use history of the internet browser application 18 and extract a route search result to a certain location as the information related to the use schedule of the rechargeable vehicle. Or, the use schedule extractor 12 may refer to a use history of the SNS application 19 and extract the use schedule of the rechargeable vehicle from a state of conversations with a friend and the like. Or, when the use schedule extractor 12 detects a candidate of a corresponding event, the use schedule extractor 12 may prompt the user to input a use schedule and receive an input of the use schedule from the user, and thereby extract the information related to the use schedule.

In the manner as described above, when the information related to the use schedule of the rechargeable vehicle is extracted, the vehicle management information generator 13 generates vehicle management information by converting the information related to the use schedule into the vehicle management information (step S2).

More specifically, the vehicle management information generator 13 acquires or derives the date and time to be used from the information related to the use schedule. Further, the vehicle management information generator 13 acquires or derives the distance to be used from the information related to the use schedule. When the information related to the use schedule includes a destination, the vehicle management information generator 13 calculates a distance from a home registered in advance to the destination by using map data (not shown in the drawings) or the like. The distance to be used may be a distance obtained by adding a predetermined margin to a return trip distance between the home and the destination. When the information related to the use schedule includes a date and information related to a time period such as morning/afternoon/all day, for example, the time period is derived according to the type of event. If the schedule is a shopping in the morning, the time period may be calculated by considering a time period used for traffic before and after a shop opening time period as a margin.

If there is a plurality of candidates of the rechargeable vehicle to be used, one type of vehicle is selected according to the information related to the use schedule and the user. For example, when a family has a large vehicle A and a small vehicle B, the vehicle management information generator 13 selects the small vehicle B if the use purpose is shopping at nearby area, and the vehicle management information generator 13 selects the large vehicle A if the use purpose is a family trip to a distant location.

Further, the vehicle management information generator 13 acquires owner information from the user of the terminal device 1.

The vehicle management information generator 13 may hold a conversion table so that specific vehicle management information is generated from the information related to the use schedule. The conversion table is a table that shows a relationship between the information related to the use schedule and the vehicle management information. The conversion table may be a table prepared in advance, a table that can be arbitrarily customized by the user, or a table which is prepared in advance and whose setting is changed by the user. When the conversion table is provided, convenience of the user is improved.

When the vehicle management information is generated, the memory controller 14 adds a unique management ID to each use schedule and writes the vehicle management information to the memory device 15 (step S3). Thereby, the HEMS server 2 can access the vehicle management information.

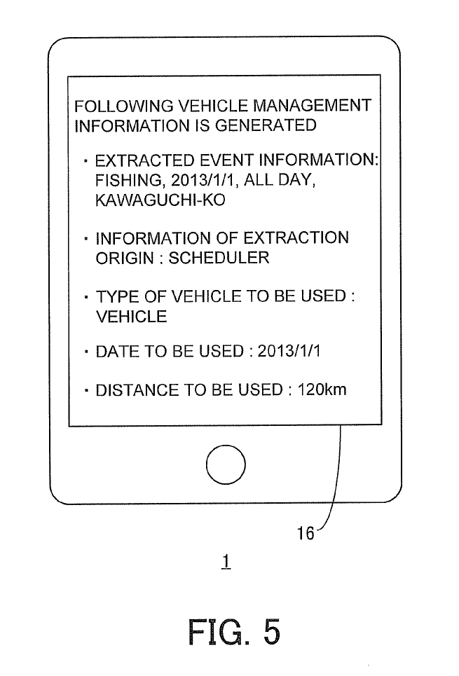

Further, the display 16 of the terminal device 1 may display the generated vehicle management information. FIG. 5 is a diagram showing an example of the vehicle management information displayed on the display 16. As shown in FIG. 5, by presenting the generated vehicle management information to the user, it is possible for the user to confirm whether or not the use schedule of the vehicle is correctly extracted. If there is some error, all or part of the vehicle management information may be modified manually.

For example, the generation of the vehicle management information by the terminal device 1 described above may be performed when the user starts the vehicle management information generation application or may be performed periodically or according to an instruction from the user by running the application at all times.

Next, the processing operation of the HEMS server 2 will be described. The merge unit 22 of the HEMS server 2 acquires the vehicle management information written to the memory device 15. When the HEMS includes a plurality of terminal devices 1, the merge unit 22 acquires the plurality of pieces of the vehicle management information. Then the merge unit 22 determines the presence or absence of use schedules overlapping each other in the plurality of pieces of the vehicle management information. For example, when the type of vehicle to be used, the date and time to be used, and the distance to be used in the vehicle management information generated in one terminal device 1 coincide with those generated in another terminal device 1, the merge unit 22 determines that both use schedules are the same.

In this case, the merge unit 22 merges the same use schedules overlapping each other into one use schedule (step S11). When the use schedules are not determined to be the same schedule and determined to be a conflict of the schedules, the merge unit 22 may re-generate new vehicle management information by using a substitute vehicle if possible or notify an information owner of an alert. The vehicle management information merged in this way is written to the memory device 26 by the memory controller 24.

Subsequently, the schedule information generator 23 acquires the (merged) vehicle management information and the status information of the rechargeable vehicle from the memory device 26. The status information includes information related to a charge state, such as remaining power and a travelable distance of the rechargeable vehicle, which is acquired from the rechargeable vehicle. The schedule information generator 23 generates the vehicle management schedule information on the basis of the vehicle management information and the status information of the rechargeable vehicle (step S12).

More specifically, the schedule information generator 23 generates the vehicle management schedule by considering the charge state of the rechargeable vehicle and determining when the rechargeable vehicle should be charged in order to charge the rechargeable vehicle to run the distance to be used before the date and time to be used. The generated vehicle management information is written to the memory device 26 by the memory controller 24.

The charge controller 25 charges the rechargeable vehicle according to the vehicle management schedule information written to the memory controller 24 (step S13).

In this way, the charging of the rechargeable vehicle is appropriately managed by the HEMS shown in FIG. 2.

Hereinafter, a usage example of the HEMS will be described. It is assumed that a user registers a schedule of “fishing” in the schedule management application 17 in the terminal device 1. In this case, the use schedule extractor 12 extracts the schedule of “fishing”.

It is assumed that a definition that a rechargeable vehicle

X is used in an event of “fishing” is registered in the vehicle management information generator 13 as a conversion table. In this case, the vehicle management information generator 13 identifies the type of vehicle to be used to be the rechargeable vehicle X by referring to the conversion table and acquires the date and time to be used and the distance to be used from the schedule extracted from the schedule management application 17. Further, the vehicle management information generator 13 acquires user information of the terminal device 1 as the owner information. The vehicle management information generated in this way is stored in the memory device 15 and referred to by the HEMS server 2.

The merge unit 22 of the HEMS server 2 determines that the use schedule of the rechargeable vehicle in the “fishing” in the vehicle management information generated by the above terminal device 1 is the same as the use schedule of the rechargeable vehicle in the same “fishing” in the vehicle management information generated by a family's terminal device 1, and integrates the use schedules into one use schedule. The schedule information generator 23 acquires the current charge state of the type of vehicle to be used on the basis of the status information and generates schedule information that indicates timing of charging so that the rechargeable vehicle is used in the “fishing” and the rechargeable vehicle can run the distance to be used. The charge controller 25 charges the rechargeable vehicle by the date and time for the rechargeable vehicle to be used in the “fishing” according to the schedule information so that the rechargeable vehicle can travel to the destination.

In this way, in the present embodiment, the use schedule of the rechargeable vehicle is extracted from the terminal device and the vehicle management information is generated. Therefore, the user need not set a use schedule in the HEMS, so that the charge management of the rechargeable vehicle can be easily performed.

At least a part of the HEMS explained in the above embodiments can be formed of hardware or software. When the HEMS is partially formed of the software, it is possible to store a program implementing at least a partial function of the HEMS in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the HEMS can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

(Appendix 1). A terminal device (1) comprising:

a use schedule extractor (12) configured to extract information related to a use schedule of a rechargeable vehicle from a use state of the terminal device (1); and

a vehicle management information generator (13) configured to generate vehicle management information necessary for charge management of the rechargeable vehicle based on the information related to the use schedule.

(Appendix 2). The terminal device (1) of appendix 1, wherein the vehicle management information comprises:

first information related to date and time to be used of the rechargeable vehicle; and

second information related a distance to be used of the rechargeable vehicle.

(Appendix 3). The terminal device (1) of appendix 2, wherein the vehicle management information further comprises third information related to a type of vehicle to be used.
(Appendix 4). The terminal device (1) of appendix 1, wherein the vehicle management information generator (13) is configured to generate the vehicle management information based on a conversion table indicative of a relationship between the information related to the use schedule and the vehicle management information, the conversion table being predefined, being set by a user or a setting of the conversion table being changed by the user.
(Appendix 5). The terminal device (1) of appendix 1 further comprising a display (16) on which the generated vehicle management information is displayed.
(Appendix 6). The terminal device (1) of appendix 1, wherein the use schedule extractor (13) is configured to extract the information related to the use schedule from an application installed in the terminal device (1).
(Appendix 7). The terminal device (1) of appendix 1, wherein the use schedule extractor (13) is configured to extract the information related to the use schedule from a schedule management application (17), an internet browser application (18) or an SNS application (19) installed in the terminal device (1).
(Appendix 8). A vehicle management information generation method comprising:

extracting (S1) information related to a use schedule of a rechargeable vehicle from a use state of the terminal device (1); and

generating (S2) vehicle management information necessary for charge management of the rechargeable vehicle based on the information related to the use schedule.

(Appendix 9). The vehicle management information generation method of appendix 8, wherein the vehicle management information comprises:

first information related to date and time to be used of the rechargeable vehicle; and

second information related a distance to be used of the rechargeable vehicle.

(Appendix 10). The vehicle management information generation method of appendix 9, wherein the vehicle management information further comprises third information related to a type of vehicle to be used.
(Appendix 11). The vehicle management information generation method of appendix 8, wherein upon generating (S2) the vehicle management information, the vehicle management information is generated based on a conversion table indicative of a relationship between the information related to the use schedule and the vehicle management information, the conversion table being predefined, being set by a user or a setting of the conversion table being changed by the user.
(Appendix 12). The vehicle management information generation method of appendix 8 further comprising displaying (S4) the generated vehicle management information. (Appendix 13). The vehicle management information generation method of appendix 8, wherein upon extracting (S1) the information related to the use schedule, the information related to the use schedule is extracted from an application installed in the terminal device (1).
(Appendix 14). The vehicle management information generation method of appendix 8, wherein upon extracting (S1) the information related to the use schedule, the information related to the use schedule is extracted from a schedule management application (17), an internet browser application (18) or an SNS application (19) installed in the terminal device (1).
(Appendix 15). A non-transitory computer readable recording medium for recording a vehicle management information generation program to cause a computer to execute:

extracting information related to a use schedule of a rechargeable vehicle from a use state of the terminal device; and

generating vehicle management information necessary for charge management of the rechargeable vehicle based on the information related to the use schedule.

(Appendix 16). The non-transitory computer readable recording medium of appendix 15, wherein the vehicle management information comprises:

first information related to date and time to be used of the rechargeable vehicle; and

second information related a distance to be used of the rechargeable vehicle.

(Appendix 17). The non-transitory computer readable recording medium of appendix 16, wherein the vehicle management information further comprises third information related to a type of vehicle to be used.
(Appendix 18). The non-transitory computer readable recording medium of appendix 15, wherein upon generating (S2) the vehicle management information, the vehicle management information is generated based on a conversion table indicative of a relationship between the information related to the use schedule and the vehicle management information, the conversion table being predefined, being set by a user or a setting of the conversion table being changed by the user.
(Appendix 19). The non-transitory computer readable recording medium of appendix 15 further comprising displaying (S4) the generated vehicle management information.
(Appendix 20). The non-transitory computer readable recording medium of appendix 15, wherein upon extracting (S1) the information related to the use schedule, the information related to the use schedule is extracted from an application installed in the terminal device (1).

1. A terminal device comprising:
a use schedule extractor configured to extract information related to a use schedule of a rechargeable vehicle from a use state of the terminal device; and
a vehicle management information generator configured to generate vehicle management information necessary for charge management of the rechargeable vehicle based on the information related to the use schedule.

2. The terminal device of claim 1, wherein the vehicle management information comprises:
first information related to date and time to be used of the rechargeable vehicle; and
second information related a distance to be used of the rechargeable vehicle.

3. The terminal device of claim 2, wherein the vehicle management information further comprises third information related to a type of vehicle to be used.

4. The terminal device of claim 1, wherein the vehicle management information generator is configured to generate the vehicle management information based on a predefined conversion table indicative of a relationship between the information related to the use schedule and the vehicle management information.

5. The terminal device of claim 1, wherein the vehicle management information generator is configured to generate the vehicle management information based on a conversion table indicative of a relationship between the information related to the use schedule and the vehicle management information, the conversion table being set by a user or a setting of the conversion table being changed by the user.

6. The terminal device of claim 1 further comprising a display on which the generated vehicle management information is displayed.

7. The terminal device of claim 1, wherein the use schedule extractor is configured to extract the information related to the use schedule from an application installed in the terminal device.

8. The terminal device of claim 1, wherein the use schedule extractor is configured to extract the information related to the use schedule from a schedule management application, an internet browser application or an SNS application installed in the terminal device.

9. A vehicle management information generation method comprising:
extracting information related to a use schedule of a rechargeable vehicle from a use state of the terminal device; and
generating vehicle management information necessary for charge management of the rechargeable vehicle based on the information related to the use schedule.

10. A non-transitory computer readable recording medium for recording a vehicle management information generation program to cause a computer to execute:
extracting information related to a use schedule of a rechargeable vehicle from a use state of the terminal device; and
generating vehicle management information necessary for charge management of the rechargeable vehicle based on the information related to the use schedule.

11. The non-transitory computer readable recording medium of claim 10, wherein the vehicle management information comprises:
first information related to date and time to be used of the rechargeable vehicle; and
second information related a distance to be used of the rechargeable vehicle.
